(19) United States
(12) Patent Application Publication
(10) Pub. No.: US 2017/0325424 A1
(43) Pub. Date: Nov. 16, 2017

(54) ANIMAL HANDLING ASSISTANCE APPARATUS AND METHOD

(71) Applicant: Christina L. Juarez, Edmond, OK (US)

(72) Inventor: Christina L. Juarez, Edmond, OK (US)

(21) Appl. No.: 15/585,759

(22) Filed: May 3, 2017

Related U.S. Application Data
(60) Provisional application No. 62/334,057, filed on May 10, 2016.

(51) Int. Cl. A01K 15/04; A47C 1/00; A01K 13/00

(52) U.S. Cl. CPC A01K 15/04; A01K 13/00; A47C 1/00

(57) ABSTRACT

Animal handling assistance system and methods are disclosed, including an animal handling assistance apparatus, comprising: a body panel; first, second, third, and fourth appendage pouches extending from side portions of the body panel receivable of appendages of an animal. The first, second, third, and fourth appendage pouches each have a proximal portion and a distal portion, with an opening on the proximal portion and on the same side as the inside surface of the body panel, with at least one pouch fastener on the distal portion attachable to the outside surface of the body panel such that at least one of first, second, third, and fourth appendage of the animal is restrainable against the body of the animal.

### BACKGROUND

Many animals become distressed or uncooperative during grooming, nail trimming, vaccinations, or other necessary handling. The animal's distress may result in accidents or injury to the animal or handler. In some cases, an animal's distress or lack of cooperation may result in a handler's decision not to work with the animal, leading to a lack of necessary grooming or medical care. Therefore, a need exists for apparatuses and methods to assist owners, service providers, and veterinary care professionals with the handling of animals.

### BRIEF DESCRIPTION OF THE SEVERAL VIEWS OF THE DRAWINGS

FIG. 1 is a top plan view of an exemplary embodiment of an animal handling assistance apparatus in accordance with the present disclosure.

FIG. 2 is a bottom plan view of an exemplary embodiment of an animal handling assistance apparatus in accordance with the present disclosure.

FIG. 3 is a bottom plan view of components of an exemplary embodiment of an animal handling assistance apparatus in accordance with the present disclosure.

FIG. 4 is a partial bottom plan view of an exemplary embodiment of an animal handling assistance apparatus in accordance with the present disclosure.

FIG. 5 is a bottom view of a detail of an exemplary embodiment of an animal handling assistance apparatus in accordance with the present disclosure.

FIG. 6 is a perspective view of the animal handling assistance apparatus of FIG. 1 in use.

FIG. 7 is another perspective view of the animal handling assistance apparatus of FIG. 1 in use.

FIG. 8 is a front perspective view of an exemplary embodiment of components of an animal handling assistance system in accordance with the present disclosure.

FIG. 9 is a front perspective view of an exemplary embodiment of components of an animal handling assistance system in accordance with the present disclosure.

FIG. 10 is a rear perspective view of the components of the animal handling assistance system of FIG. 9.

FIG. 11 is a front view of an exemplary embodiment of an animal handling assistance system in accordance with the present disclosure in use.

FIG. 12 is a front partial view of the animal handling assistance apparatus of FIG. 1 in use.

### DETAILED DESCRIPTION OF EXEMPLARY EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

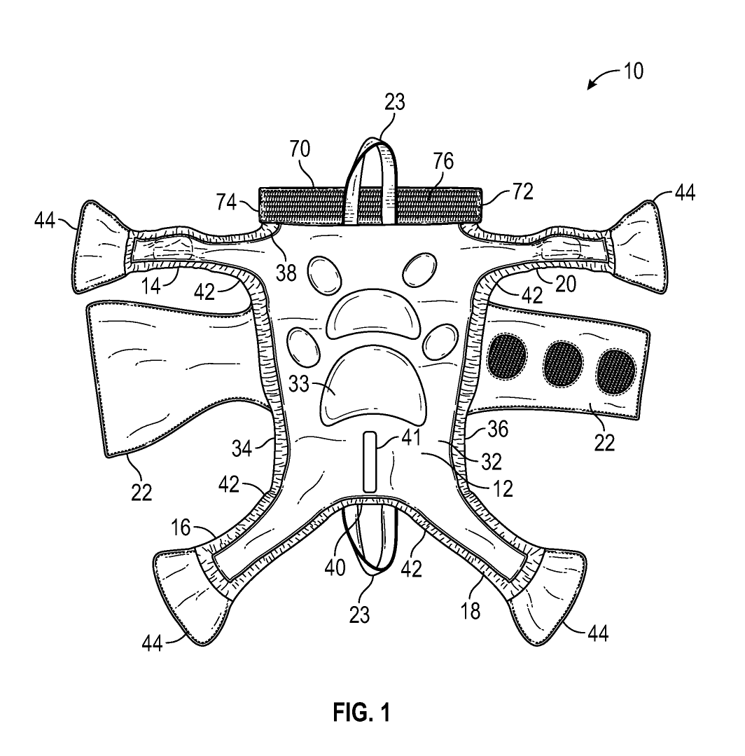

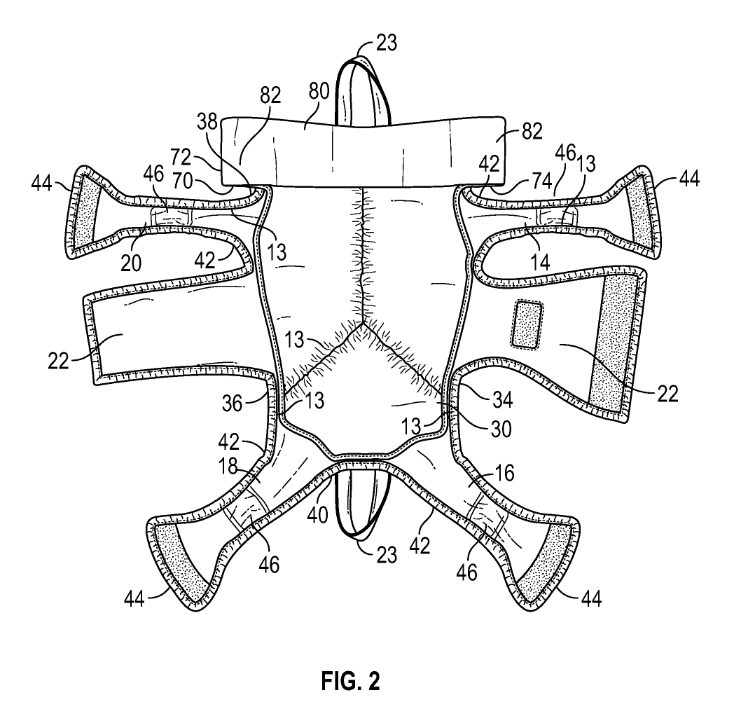

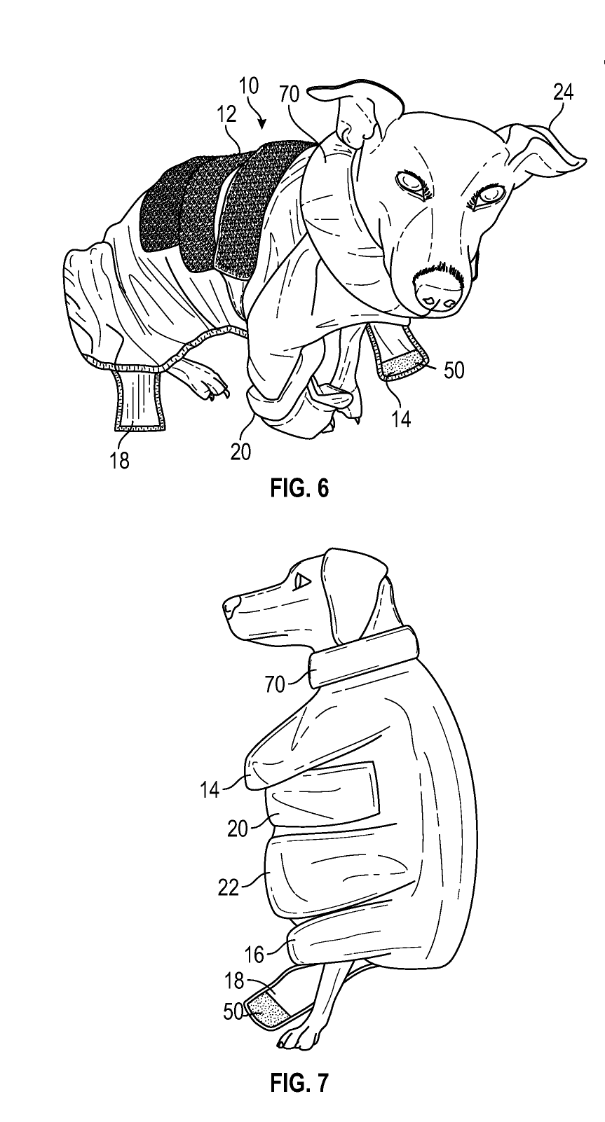

Referring now to the drawings, FIGS. 1 and 2 illustrate an exemplary embodiment of an animal handling assistance apparatus 10 in accordance with the present disclosure. The animal handling assistance apparatus 10 comprises a body panel 12, a first appendage pouch 14, a second appendage pouch 16, a third appendage pouch 18, a fourth appendage pouch 20, and a strap 22. The animal handling assistance apparatus 10 may be worn by an animal 24 (see FIGS. 6, 7, and 11).

The body panel 12 has an inside surface 30 and an outside surface 32, a first side portion 34, a second side portion 36, a front portion 38, and a rear portion 40.

The body panel 12 may be made of cloth or other suitable material. In one embodiment, the body panel 12 is made of a material such that the body panel 12 is snugly securable about the body of the animal 24. In one embodiment, the material is flexible.

In one embodiment, the outside surface 32 of the body panel 12 is comprised of a cotton duck material (also known as duck canvas). In one embodiment, the inside surface 30 of the body panel 12 is comprised of a flannel or brushed cotton material.

As illustrated in FIG. 2, in one embodiment, the body panel 12 has one or more expandable sections 13. In one embodiment, one or more of the expandable sections 13 may be comprised of one or more elastic inserts. The expandable section(s) 13 may be located laterally, longitudinally, and/or along the edges of the body panel 12.

As illustrated in FIGS. 1 and 2, in one embodiment, the animal handling assistance apparatus 10 may further comprise one or more handle 23. The one or more handle 23 may be two handles 23, wherein one handle 23 extends from the front portion 38 of the body panel 12 and another handle 23 extends from the rear portion 40 of the body panel 12. Additionally, or alternately, the one or more handle 23 may extend from other portions of the body panel 12.

In one embodiment, as shown in FIG. 1, the body panel 12 has at least one aperture 41 such that a portion of the body of the animal is accessible through the aperture 41. In one embodiment, the aperture 41 is located proximate to the rear portion 40 of the body panel 12. In one embodiment, the aperture 41 may be covered by a flap. In one embodiment, the aperture may be closeable with a fastener, such as a zipper or a hook and loop type fastener.

The first appendage pouch 14 extends from the first side portion 34 of the body panel 12 and is located proximate to the front portion 38 of the body panel 12. The first appendage pouch 14 is receivable of a first appendage of the animal 24.

The second appendage pouch 16 extends from the first side portion 34 of the body panel 12 and is located proximate to the rear portion 40 of the body panel 12. The second appendage pouch 16 is receivable of a second appendage of the animal 24.

The third appendage pouch 18 extends from the second side portion 36 of the body panel 12 and is located proximate to the rear portion 40 of the body panel 12. The third appendage pouch 18 is receivable of a third appendage of the animal 24.

The fourth appendage pouch 20 extends from the second side portion 36 of the body panel 12 and is located proximate to the front portion 38 of the body panel 12. The fourth appendage pouch 20 is receivable of a fourth appendage of the animal 24.

As shown in FIGS. 1 and 2, the first, second, third, and fourth appendage pouches 14, 16, 18, 20 each have a proximal portion 42 and a distal portion 44, with an opening 46 on the proximal portion 42. The opening 46 is located on the same side as the inside surface 30 of the body panel 12 (see FIG. 5). The first, second, third, and fourth appendage pouches 14, 16, 18, 20 are restrainable against the body of the animal 24. The first, second, third, and fourth appendage pouches 14, 16, 18, 20 may each have at least one pouch fastener 50 on the distal portion 44 attachable to the outside surface 32 of the body panel 12 such that at least one of the first, second, third, and fourth appendages of the animal 24 is restrainable against the body of the animal 24. More than one, or all, or all but one, of the appendage pouches 14, 16, 18, 20 may be attached to the outside surface 32 of the body panel 12 so as to restrain more than one, or all, or all but one of the appendages of the animal 24 at the same time.

In one embodiment, the appendage pouches 14, 16, 18, 20 are attachable to a center portion of the outside surface of the body panel 12 such that the appendages of the animal 24 are crossed over the body of the animal 24 when the appendages are restrained.

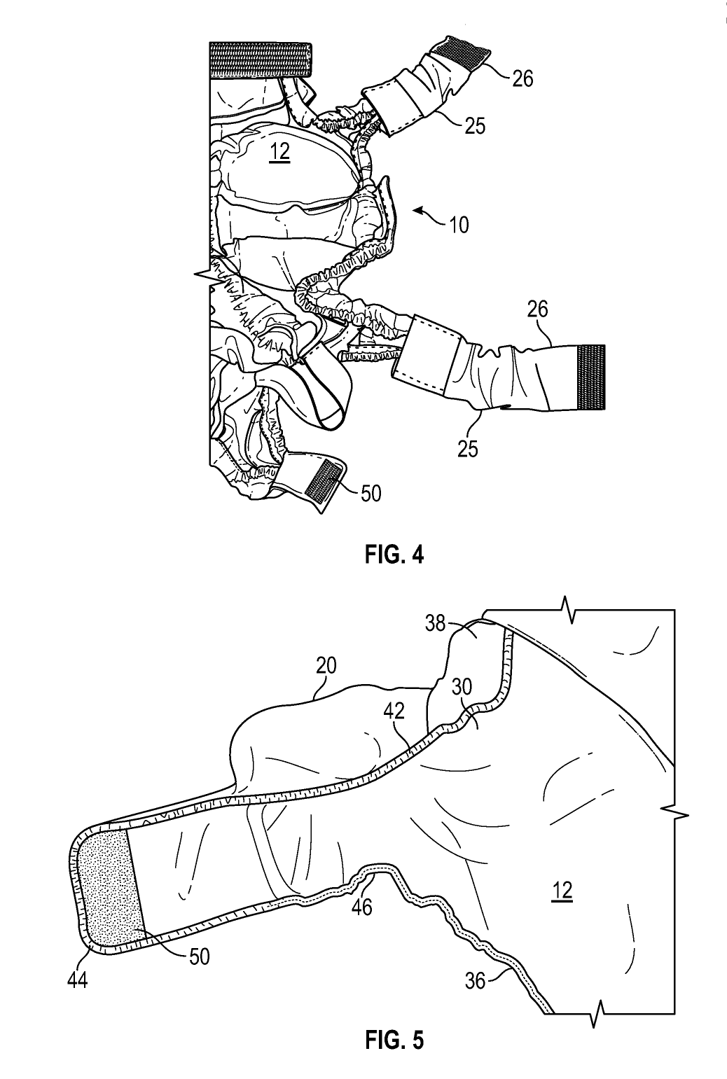

As shown in FIG. 4, in one embodiment, one or more extender 25 may be attached to the first, second, third, or fourth appendage pouches 14, 16, 18, 20 such that the one or more extender 25 may be attached to the outside surface 32 of the body panel 12. The one or more extender 25 may have at least one fastener 26 for attachment to the body panel 12. The one or more extender 25 may have an adjustable length and/or may comprise expandable material, such as elastic. In one embodiment, the extender 25 may be attachable to the pouch fastener 50.

In one embodiment, the pouch fastener 50 is one of hook fasteners or loop fasteners and the outside surface 32 of the body panel 12 has one of the other of hook fasteners or loop fasteners.

In one embodiment, the strap 22 may extend from the first side portion 34 of the body panel 12 between the first appendage pouch 14 and the second appendage pouch 16. The strap 22 may have at least one strap fastener 60 attachable to the outside surface 32 of the body panel 12 and/or to the strap 22 such that the strap 22 secures the body panel 12 about the body of the animal 24. In one embodiment, the strap 22 may have an adjustable length.

In one embodiment, the strap 22 may be a first strap 22 and the animal handling assistance apparatus 10 may further comprise a second strap 22 extending from the second side portion 36 of the body panel 12. The first strap 22 and the second strap 22 may be matingly engageable about the body of the animal 24. In one embodiment, the first strap 22 and the second strap 22 may be matingly engageable about the body of the animal 24 using fasteners, non-exclusive examples of which include hook and loop fasteners, hook and eye fasteners, snaps, buckles, and buttons.

In one embodiment, the body panel 12, one or more of the first, second, third, and fourth appendage pouches 14, 16, 18, 20, and the strap 22 may be formed as one piece and/or from one piece of material. Alternately, one or more of the first, second, third, and fourth appendage pouches 14, 16, 18, 20, and/or the strap 22 may be formed from multiple pieces and/or different pieces of material than the body panel 12.

As shown in FIGS. 1-3, in one embodiment, the animal handling assistance apparatus 10 further comprises a neck portion 70 extending along the front portion 38 of the body panel 12. The neck portion 70 may have a first end 72 and a second end 74 attachable to the first end 72 when the neck portion 70 is placed around the neck of the animal 24. In one embodiment, the first end 72 and the second end 74 each has a neck portion fastener 76. In one embodiment, the neck portion fastener 76 of the first end is one of hook fasteners or loop fasteners and the neck portion fastener 76 of the second end is one of the other of hook fasteners or loop fasteners. Of course, it will be understood that the neck portion fastener 76 may be chosen from other types of fasteners, non-exclusive examples of which include snaps, eye-hooks, quick release fasteners, and buckles.

In one embodiment, the neck portion 70 is removable from the body panel 12. In one embodiment, the height of the neck portion 70 is adjustable.

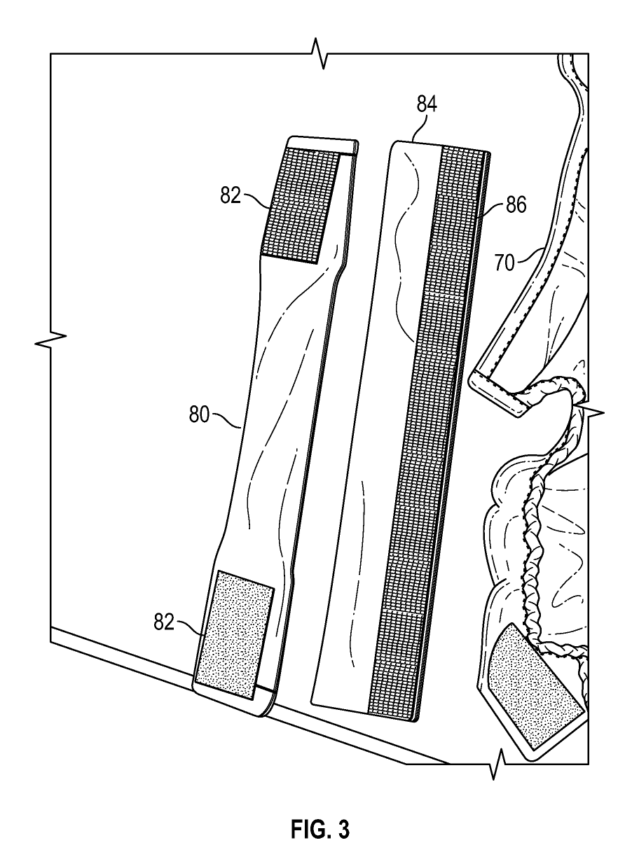

In one embodiment, as shown in FIGS. 2 and 3, the neck portion 70 has a stiffened piece 80 such that the neck portion 70 limits vertical movement of the neck of the animal 24 when the neck portion 70 is placed around the neck of the animal 24. The stiffened piece 80 of the neck portion 70 may prevent the teeth of the animal 24 from reaching the handler as the handler works with the appendages of the animal 24. In one embodiment, the stiffened piece 80 is removable from the neck portion 70. The stiffened piece 80 may have one or more fastener 82 to attach the stiffened piece 80 to the neck portion 70. In one embodiment, the stiffened piece 80 is adjustable such that the length of the stiffened piece 80 may be adjusted to fit different sizes of animals 24. The stiffened piece 80 may have one or more fastener 82 to adjust the position and/or the length of and/or attach the stiffened piece 80.

In one embodiment, as shown in FIG. 3, the animal handling assistance apparatus 10 further comprises a neck portion extender 84 that may be attached to the neck portion 70 to extend the height of the neck portion 70. The neck portion extender 84 may be used to attach to the neck portion 70 for an animal 24 with a longer neck such that the stiffened piece 80 may be attached to the neck portion extender 84 to prevent the animal 24 from biting the handler while the handler works with the animal 24. The neck portion extender 84 may have one or more fastener 86.

In one embodiment, one or more components of the animal handling assistance apparatus 10 are infused with or capable of being infused with one or more essential oils, essences, and/or blend of essential oils and/or pheromones (not shown). In one embodiment, an additional component (not shown) is infused with one or more essential oils and/or blend of essential oils and/or pheromones and is attachable to the animal handling assistance apparatus 10. In one embodiment, the one or more essential oils or blend of essential oils promotes stress and/or anxiety reduction in the animal 24. In one embodiment, the one or more essential oils or blend of essential oils and/or essences and/or oils may be chosen from the group consisting of copaifera reticulata (copaiba) oil, citrus aurantifolia (lime) oil, cedrus atlantica (cedarwood) bark oil, vanilla planifolia (vanilla) absolute, ocotea quixos (ocotea) oil, lavandula angustifolia (lavender) oil, citrus reticulata (tangerine) peel oil, citrus aurantium dulcis (orange) peel oil, cananga odorata (ylang ylang) flower oil, pogostemon cablin (patchouli) oil, tanacetum annuum (blue tansy) oil, geranium oil, mandarin oil, bergamot oil, neroli oil, jasmine oil, frankincense oil, chamomile oil, cherry plum oil, clematis oil, impatiens oil, rock rose oil, star of Bethlehem flower oil, and lemon oil.

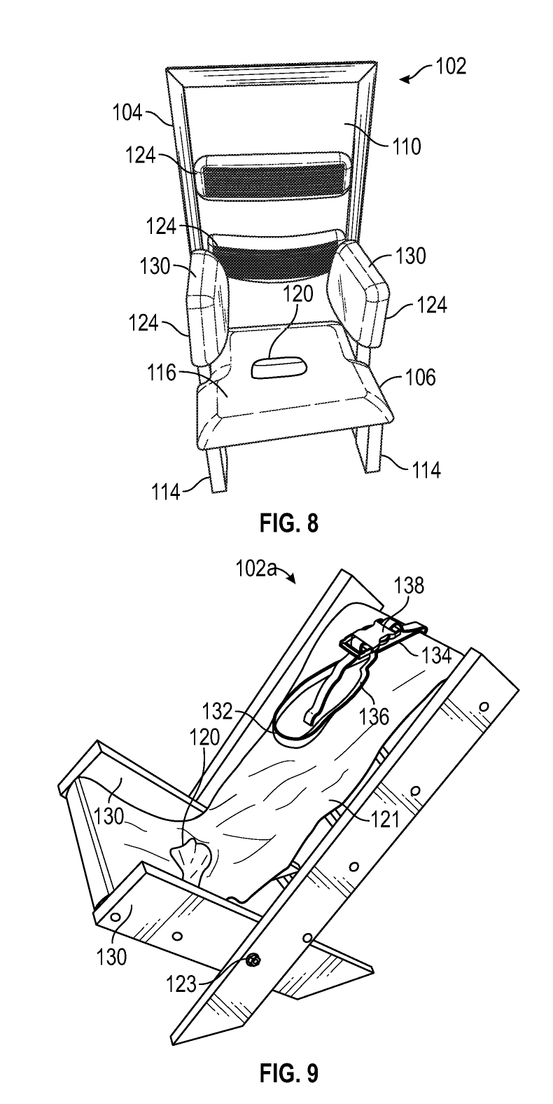

Referring now to FIGS. 6 and 7, an exemplary method of use of the animal handling assistance apparatus 10 will now be described. It will be understood that the steps of the method do not necessarily have to be carried out in the order described, except where specifically stated.

A handler of the animal 24 may place the inside surface 30 of the body panel 12 of the animal handling assistance apparatus 10 on the back of the animal 24. The handler may position the strap(s) 22 about the midsection of the animal 24 such that the body panel 12 is secured about the animal 24. The handler may attach the least one strap fastener 60 to the outside surface 32 of the body panel 12 such that the strap 22 secures the body panel 12 about the body of the animal 24 and/or may attach the first strap 22 to the second strap 22. The handler may fasten the neck portion 70 about the neck of the animal. In one embodiment in which the stiffened piece 80 of the neck portion 70 is removable, the handler may attach the stiffened piece 80 of the neck portion 70. If necessary, dependent on the length of the neck of the animal 24, the handler may attach the neck portion extender 84 to the neck portion 70 before attaching the stiffened piece 80.

The handler may place the first appendage of the animal 24 in the first appendage pouch 14, the second appendage of the animal 24 in the second appendage pouch 16, the third appendage of the animal 24 in the third appendage pouch 18 and the fourth appendage of the animal 24 in the fourth appendage pouch 20, through the openings 46 of the first, second, third, and fourth appendage pouches 14, 16, 18, 20.

The handler may attach the at least one pouch fastener 50 on the distal portions 44 of the first, second, third, and fourth appendage pouches 14, 16, 18, 20 to the outside surface 32 of the body panel 12 such that at least one of the first, second, third, and fourth appendage of the animal 24 is restrained against the body of the animal 24. The handler may cross the appendages of the animal 24 across the front of the body of the animal 24 in attaching the appendage pouches 14, 16, 18, 20 to the outside surface 32 of the body panel 12.

The handler may attach the first, second, third, and fourth appendage pouches 14, 16, 18, 20 to the outside surface 32 of the body panel 12 such that all of the first, second, third, and fourth appendages of the animal 24 are restrained against the body of the animal 24.

It will be understood that the handler may attach the first, second, third, and fourth appendage pouches 14, 16, 18, 20 to the outside surface 32 of the body panel 12 in any order.

In one embodiment, the handler may use the one or more extender 25 attachable to the first, second, third, and/or fourth appendage pouches 14, 16, 18, 20 to attach the first, second, third, and/or fourth appendage pouches 14, 16, 18, 20 to the outside surface 32 of the body panel 12. For example, the one or more extender 25 may be used when the legs of the animal 24 are short and additional length is needed to secure the legs of the animal 24 to the outside surface 32 of the body panel 12.

In one embodiment as shown in FIG. 7, in use, the handler may detach the pouch fastener 50 of the first appendage pouch 14 from the outside surface 32 of the body panel 12 and remove the first appendage of the animal 24 from the first appendage pouch 14, such as to safely handle the first appendage. For example, the handler may trim the nails of the animal 24 or provide veterinary care to the first appendage. Once care has been provided, the handler may place the first appendage back in the first appendage pouch 14, and re-attach the pouch fastener 50 to the outside surface 32 of the body panel 12 such that the first appendage of the animal 24 is restrained against the body of the animal 24.

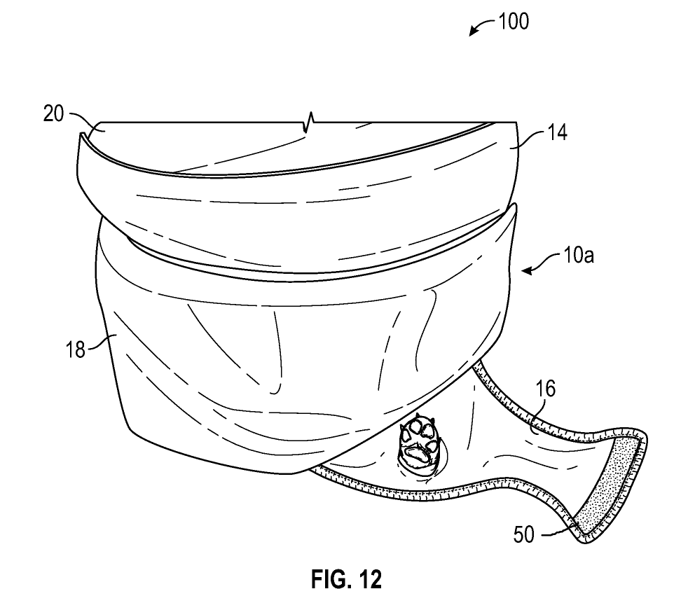

The handler may detach the pouch fastener 50 of the second appendage pouch 16 from the outside surface 32 of the body panel 12 and remove the second appendage of the animal 24 from the second appendage pouch 16, so as to safely handle the second appendage (see FIG. 12). Once care has been provided, the handler may place the second appendage back in the second appendage pouch 16, and re-attach the pouch fastener 50 to the outside surface 32 of the body panel 12 such that the second appendage of the animal 24 is restrained against the body of the animal 24.

The handler may detach the pouch fastener 50 of the third appendage pouch 18 from the outside surface 32 of the body panel 12 and remove the third appendage of the animal 24 from the third appendage pouch 18, so as to safely handle the third appendage. Once care has been provided, the handler may place the third appendage back in the third appendage pouch 18, and re-attach the pouch fastener 50 to the outside surface 32 of the body panel 12 such that the third appendage of the animal 24 is restrained against the body of the animal 24.

The handler may detach the pouch fastener 50 of the fourth appendage pouch 20 from the outside surface 32 of the body panel 12 and remove the fourth appendage of the animal 24 from the fourth appendage pouch 20, so as to safely handle the fourth appendage. Once care has been provided, the handler may place the fourth appendage back in the fourth appendage pouch 20, and re-attach the pouch fastener 50 to the outside surface 32 of the body panel 12 such that the fourth appendage of the animal 24 is restrained against the body of the animal 24.

Of course, it will be understood that the handler may attach or detach one or more of the first, second, third, and fourth appendage pouches 14, 16, 18, 20 in any number, order, or combination.

In one embodiment, the handler may utilize the one or more handle 23 to position the animal 24.

In one embodiment, the handler may provide care to the animal 24, for example, administer vaccinations, through the aperture 41 in the body panel 12.

When the handler has completed the care of the animal 24, the handler may remove the animal handling assistance apparatus 10 from the animal 24.

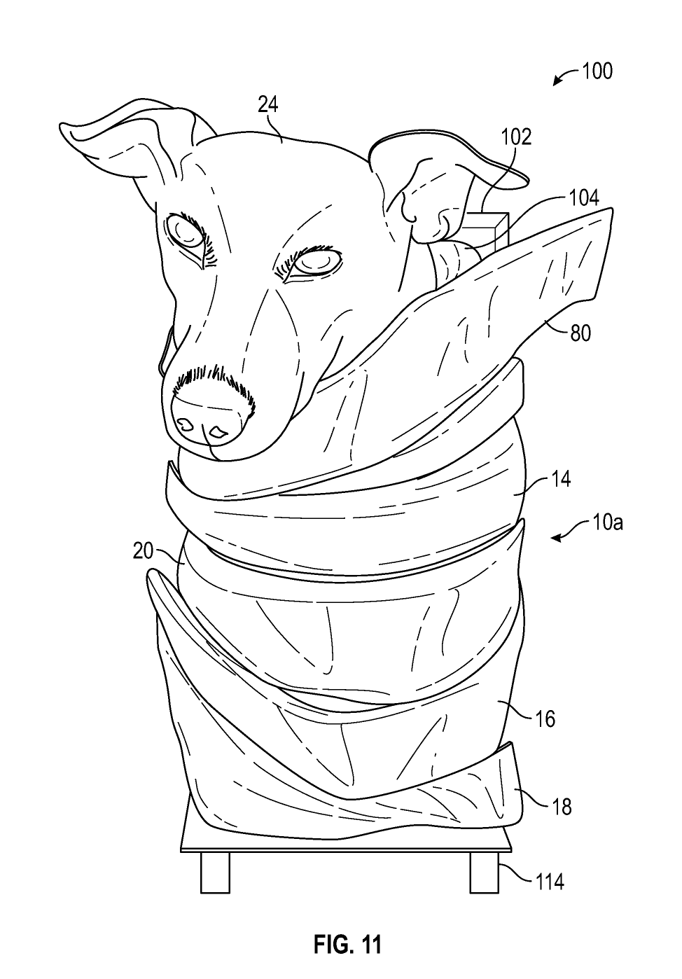

FIGS. 8 and 11 illustrate exemplary embodiments of an animal handling assistance system 100 comprising a chair 102 and an animal handling assistance apparatus 10a constructed in accordance with the inventive concepts disclosed herein. The animal handling assistance apparatus 10a is substantially similar to the animal handling assistance apparatus 10, except as described herein below.

The chair 102 has a back support portion 104 and a seat portion 106. The back support portion 104 has a front portion 110 and a rear portion 112. In one embodiment, the chair 102 may have one or more legs 114 connected to the back support portion 104 and/or the seat portion 106.

The seat portion 106 has a top 116 and a bottom 118. In one embodiment, as shown in FIG. 8, the seat portion 106 has a center portion 120 comprised of a compressible material deformable to accommodate a tail of the animal 24.

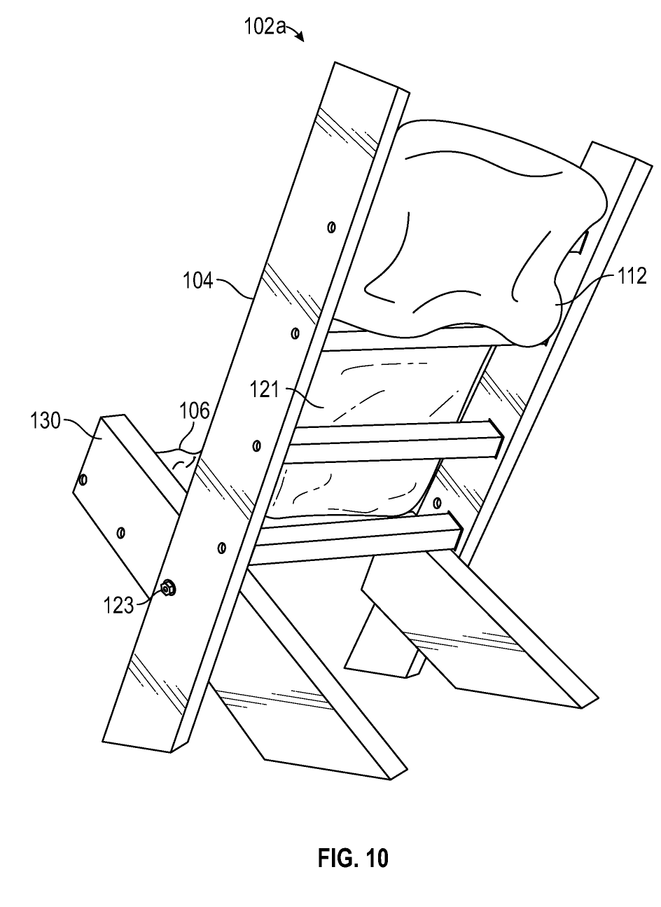

FIGS. 9 and 10 illustrate another exemplary embodiment of an animal handling assistance system 100 comprising a chair 102a and the animal handling assistance apparatus 10a constructed in accordance with the inventive concepts disclosed herein. In one embodiment, the chair 102a may have a removable cover 121. In one embodiment, the removable cover 121 has the center portion 120 comprised of a compressible material deformable to accommodate a tail of the animal 24. In one embodiment the chair 102a is foldable for ease of storage and portability. In one embodiment, the chair 102a may pivot about a pivot mechanism 123 between the back support portion 104 and the seat portion 106 such that the chair 102a is foldable.

The animal handling assistance apparatus 10a is attachable to the chair 102, 102a such that the animal 24 encompassed by the animal handling assistance apparatus 10a is secured to the chair 102, 102a. In one embodiment, the animal handling assistance apparatus 10a is attachable to the chair 102, 102a such that the animal 24 encompassed by the animal handling assistance apparatus 10a is secured to the chair 102, 102a and one or more of the first, second, third, and fourth appendage pouches 14, 16, 18, 20 are accessible to the handler.

In one embodiment, the animal handling assistance apparatus 10a may have one or more panel fastener 122 on the outside surface 32 of the body panel 12. The chair 102 may have one or more chair fastener(s) 124. The animal handling assistance apparatus 10a may be attachable to the chair 102 by connecting the panel fastener(s) 122 and the chair fastener(s) 124.

In one embodiment, the one or more chair fasteners 124 may be located on the front portion 110 of the back support portion 104 and/or the seat portion 106 of the chair 102.

In one embodiment, one or more of the chair fasteners 124 are one of hook fasteners or loop fasteners and one or more of the panel fasteners 122 are one of the other of hook fasteners or loop fasteners.

In one embodiment, the strap 22 may be attachable to the chair 102. In one embodiment, the strap 22 may be attachable about the rear portion 112 of the back support portion 104 of the chair 102. In one embodiment, one or more of the chair fasteners 124 may be located on the rear portion 112 of the back support portion 104 of the chair 102. The animal handling assistance apparatus 10a may be attachable to the chair 102 by connecting the strap 22 and the chair fastener(s) 124 on the rear portion 112 of the back support portion 104 of the chair 102.

In one embodiment, a body strap (not shown) may be used to secure the animal 24 to the chair 102, 102a. The body strap may be fastened around the body of the animal 24 and fastened to, attached to, and/or secured about the chair 102, 102a. In one embodiment, the body strap is adjustable to the size of the animal 24.

In one embodiment, the chair 102 has at least one side support 130. The side support (s) 130 may be connected to the back support portion 104 and/or the seat portion 106. The side support (s) 130 may have one or more of the chair fasteners 124 attachable to the animal handling assistance apparatus 10a. In one embodiment, the animal handling assistance apparatus 10a may be attachable to the chair 102 by connecting the panel fastener(s) 122 and the chair fastener(s) 124 on the side support (s) 130. In one embodiment, the animal handling assistance apparatus 10a may be attachable to the chair 102 by connecting the strap 22 to the side support(s) 130. In one embodiment, the animal handling assistance apparatus 10a may be attachable to the chair 102 by connecting the strap 22 to the chair fastener(s) 124 on the side support (s) 130.

In one embodiment, the first, second, third, and/or fourth appendage pouches 14, 16, 18, 20 may be attachable to the chair 102, 102a to restrain the appendage(s) of the animal 24. In one embodiment, the first, second, third, and/or fourth appendage pouches 14, 16, 18, 20 may be attachable to the chair fastener(s) 124, such as the chair fasteners 124 on the side support (s) 130 of the chair 102.

In one embodiment, a collar strap 132 is attachable to the chair 102, 102a and/or the cover 121 of the chair 102, 102a. The collar strap 132 is further attachable to the animal handling assistance apparatus 10a and/or about the neck or body of the animal 24. The collar strap 132 may have a first end 134 and a second end 136 and a connector 138 to connect the first end 134 and the second end 136. In one embodiment, the collar strap 132 is adjustable to the size of the body of the animal 24.

Elements shown in conjunction with chair 102 may be interchanged with, or combined with, elements shown in conjunction with chair 102a, and vice versa.

Referring now to FIGS. 11 and 12, an example of one embodiment of the animal handling assistance system 100 in use in accordance with the present disclosure will be described. It will be understood that the steps of the method do not necessarily have to be carried out in the order described, except where specifically stated.

A handler of the animal 24 may place the inside surface 30 of the body panel 12 of the animal handling assistance apparatus 10a on the back of the animal 24. The handler may position the strap 22 about the midsection of the animal 24 such that the body panel 12 is secured about the animal 24. The handler may attach the least one strap fastener 60 to the outside surface 32 of the body panel 12 and/or to the strap 22 such that the strap 22 secures the body panel 12 about the body of the animal 24.

The handler may fasten the neck portion 70 about the neck of the animal 24. In one embodiment, the handler may attach the stiffened piece 80 of the neck portion 70 to the neck portion 70. In one embodiment, the handler may attach the neck portion extender 84 to the neck portion 70 before attaching the stiffened piece 80 to the neck portion extender 84.

The handler may place the first appendage of the animal 24 in the first appendage pouch 14, the second appendage of the animal 24 in the second appendage pouch 16, the third appendage of the animal 24 in the third appendage pouch 18 and the fourth appendage of the animal 24 in the fourth appendage pouch 20, through the openings 46 of the first, second, third, and fourth appendage pouches 14, 16, 18, 20.

The handler may attach the at least one pouch fastener 50 on the distal portions 44 of the first, second, third, and fourth appendage pouches 14, 16, 18, 20 to the outside surface 32 of the body panel 12 such that at least one of the first, second, third, and fourth appendage of the animal 24 is restrained against the body of the animal 24.

The handler may attach the first, second, third, and fourth appendage pouches 14, 16, 18, 20 to the outside surface 32 of the body panel 12 such that all of the first, second, third, and fourth appendages of the animal 24 are restrained against the body of the animal 24.

The handler may place the animal 24 encompassed by the animal handling assistance apparatus 10a in the chair 102, 102a. In one embodiment, the handler may utilize the handle(s) 23 to place the animal 24 in the chair 102, 102a. In one embodiment, the handler may attach the one or more of the panel fasteners 122 and/or the strap 22 to the chair 102, 102a and/or to the chair fasteners 124. In one embodiment, the handler may secure the collar strap 132 and/or the body strap about the body of the animal 24 and/or to the animal handling assistance apparatus 10a and/or the chair 102, 102a.

In one embodiment, the handler may attach one or more of the first, second, third, and fourth appendage pouches 14, 16, 18, 20 to the chair 102, 102a to restrain the appendage(s) of the animal 24. In one embodiment, the handler may attach one or more of the first, second, third, and fourth appendage pouches 14, 16, 18, 20 to the chair fastener(s) 124, such as the chair fasteners 124 on the side support (s) 130 of the chair 102.

In one embodiment, in use, the handler may detach the pouch fastener 50 of the first appendage pouch 14 from the outside surface 32 of the body panel 12 and remove the first appendage of the animal 24 from the first appendage pouch 14, so as to safely handle the first appendage. For example, the handler may trim the nails of the animal 24 or provide veterinary care to the first appendage. Once care has been provided, the handler may place the first appendage back in the first appendage pouch 14, and re-attach the pouch fastener 50 to the outside surface 32 of the body panel 12 such that the first appendage of the animal 24 is restrained against the body of the animal 24.

The handler may detach the pouch fastener 50 of the second appendage pouch 16 from the outside surface 32 of the body panel 12 and remove the second appendage of the animal 24 from the second appendage pouch 16, so as to safely handle the second appendage (see FIG. 12). Once care has been provided, the handler may place the second appendage back in the second appendage pouch 16, and re-attach the pouch fastener 50 to the outside surface 32 of the body panel 12 such that the second appendage of the animal 24 is restrained against the body of the animal 24.

The handler may detach the pouch fastener 50 of the third appendage pouch 18 from the outside surface 32 of the body panel 12 and remove the third appendage of the animal 24 from the third appendage pouch 18, so as to safely handle the third appendage. Once care has been provided, the handler may place the third appendage back in the third appendage pouch 18, and re-attach the pouch fastener 50 to the outside surface 32 of the body panel 12 such that the third appendage of the animal 24 is restrained against the body of the animal 24.

The handler may detach the pouch fastener 50 of the fourth appendage pouch 20 from the outside surface 32 of the body panel 12 and remove the fourth appendage of the animal 24 from the fourth appendage pouch 20, so as to safely handle the fourth appendage. Once care has been provided, the handler may place the fourth appendage back in the fourth appendage pouch 20, and re-attach the pouch fastener 50 to the outside surface 32 of the body panel 12 such that the fourth appendage of the animal 24 is restrained against the body of the animal 24.

Of course, it will be understood that the handler may attach or detach one or more of the first, second, third, and fourth appendage pouches 14, 16, 18, 20 in any number, order, or combination.

In one embodiment, in use, the handler may provide care to the animal 24, for example, administer vaccinations, through the aperture 41 in the body panel 12.

It will also be understood that other care may be provided to the animal 24, such as dental, other veterinary care, or grooming.

When the handler has completed the care of the animal 24, the handler may detach the animal handling assistance apparatus 10a from the chair 102, 102a and remove the animal handling assistance apparatus 10a from the animal 24.

While several embodiments of the inventive concepts have been described for purposes of this disclosure, it will be understood that numerous changes may be made which will readily suggest themselves to those skilled in the art and which are accomplished within the spirit of the inventive concepts disclosed and as defined in the appended claims.

What is claimed is:

1. An animal handling assistance apparatus, comprising:
a body panel having an inside surface and an outside surface, a first side portion, a second side portion, a front portion, and a rear portion;
a first appendage pouch extending from the first side portion of the body panel and proximate to the front portion of the body panel receivable of a first appendage of an animal;
a second appendage pouch extending from the first side portion of the body panel and proximate to the rear portion of the body panel receivable of a second appendage of the animal;
a third appendage pouch extending from the second side portion of the body panel and proximate to the front portion of the body panel receivable of a third appendage of the animal;
a fourth appendage pouch extending from the second side portion of the body panel and proximate to the rear portion of the body panel receivable of a fourth appendage of the animal;
wherein the first, second, third, and fourth appendage pouch each have a proximal portion and a distal portion, with an opening on the proximal portion and on the same side as the inside surface of the body panel, and with at least one pouch fastener on the distal portion attachable to the outside surface of the body panel such that the first, second, third, and fourth appendages of the animal are restrainable against the body of the animal; and
at least one strap extending from the first side portion of the body panel between the first appendage pouch and the second appendage pouch and having at least one strap fastener such that the strap secures the body panel about the body of the animal.

2. The animal handling assistance apparatus of claim 1, wherein the strap is attachable to the outside surface of the body panel and wherein the pouch fastener is one of hook fasteners or loop fasteners and wherein the outside surface of the body panel has one of the other of hook fasteners or loop fasteners.

3. The animal handling assistance apparatus of claim 1, further comprising a neck portion extending along the front portion of the body panel, the neck portion having a first end and a second end attachable to the first end when the neck portion is placed around a neck of the animal.

4. The animal handling assistance apparatus of claim 3, wherein the neck portion has a stiffened piece such that the stiffened piece limits vertical movement of the neck of the animal when the stiffened piece is placed around the neck of the animal.

5. The animal handling assistance apparatus of claim 1, wherein one or more of the first, second, third, and fourth appendage of the animal are restrainable against the body of the animal at the same time.

6. The animal handling assistance apparatus of claim 1, wherein the body panel has at least one aperture proximate to the rear portion such that a portion of the body of the animal is accessible through the aperture.

7. The animal handling assistance apparatus of claim 1, wherein the body panel is comprised of a flexible cloth such that the body panel is snugly securable about the body of the animal.

8. The animal handling assistance apparatus of claim 1, wherein the body panel is infused with one or more essential oil.

9. A method of use of an animal handling assistance apparatus, comprising:
placing an inside surface of a body panel of an animal handling assistance apparatus on an animal, the body panel having and an outside surface, a first side portion, a second side portion, a front portion, and a rear portion;
placing a first appendage of the animal in a first appendage pouch extending from the first side portion of the body panel and proximate to the front portion of the body panel;
placing a second appendage of the animal in a second appendage pouch extending from the first side portion of the body panel and proximate to the rear portion of the body panel;
placing a third appendage of the animal in a third appendage pouch extending from the second side portion of the body panel and proximate to the front portion of the body panel;
placing a fourth appendage of the animal in a fourth appendage pouch extending from the second side portion of the body panel and proximate to the rear portion of the body panel; wherein the first, second, third, and fourth appendage pouch each have a proximal portion and a distal portion, with an opening on the proximal portion and on the same side as the inside surface of the body panel, and with at least one pouch fastener on the distal portion;
attaching a strap extending from the first side portion of the body panel between the first appendage pouch and the second appendage pouch, and having at least one strap fastener, to the outside surface of the body panel such that the strap secures the body panel about the body of the animal; and
attaching at least one of the pouch fasteners to the outside surface of the body panel such that at least one of the first, second, third, and fourth appendage of the animal is restrained against the body of the animal.

10. The method of claim 9, wherein attaching at least one of the pouch fasteners to the outside surface of the body panel such that at least one of the first, second, third, and fourth appendage of the animal is restrained against the body of the animal further comprises attaching all of the pouch fasteners to the outside surface of the body panel such that the first, second, third, and fourth appendage of the animal are restrained against the body of the animal, the method further comprising:
detaching the pouch fastener of the first appendage pouch from the outside surface of the body panel; and
removing the first appendage of the animal from the first appendage pouch.

11. The method of claim 9, further comprising trimming one or more nails of the first appendage.

12. The method of claim 9, further comprising placing a stiffened piece of a neck portion about a neck of the animal to limit vertical movement of the neck.

13. An animal handling assistance system, comprising:
a chair having a back support portion and a seat portion; and
an animal handling assistance apparatus, comprising:
a body panel having an inside surface and an outside surface, a first side portion, a second side portion, a front portion, and a rear portion;
a first appendage pouch extending from the first side portion of the body panel and proximate to the front portion of the body panel receivable of a first appendage of an animal;
a second appendage pouch extending from the first side portion of the body panel and proximate to the rear portion of the body panel receivable of a second appendage of the animal;
a third appendage pouch extending from the second side portion of the body panel and proximate to the front portion of the body panel receivable of a third appendage of the animal;
a fourth appendage pouch extending from the second side portion of the body panel and proximate to the rear portion of the body panel receivable of a fourth appendage of the animal;
wherein the first, second, third, and fourth appendage pouch each have a proximal portion and a distal portion, with an opening on the proximal portion and on the same side as the inside surface of the body panel, and with at least one pouch fastener on the distal portion attachable to the outside surface of the body panel such that at least one of the first, second, third, and fourth appendage of the animal is restrainable against the body of the animal; and
a strap extending from the first side portion of the body panel between the first appendage pouch and the second appendage pouch and having at least one strap fastener such that the strap secures the body panel about the body of the animal.
wherein the animal handling assistance apparatus is attachable to the chair such that an animal encompassed by the animal handling assistance apparatus is secured to the chair.

14. The animal handling assistance system of claim 13, wherein the body panel has a panel fastener on the outside surface and the chair has a chair fastener on the back support portion such that the animal handling assistance apparatus is attachable to the chair by connecting the panel fastener and the chair fastener.

15. The animal handling assistance system of claim 13, wherein the strap is attachable to the outside surface of the body panel.

16. The animal handling assistance system of claim 13, wherein the seat portion of the chair has a center portion comprised of a compressible material deformable to accommodate a tail of the animal.

17. The animal handling assistance system of claim 13, wherein the animal handling assistance apparatus further comprises a neck portion with a stiffened piece positionable about a neck of the animal to limit vertical movement of the neck of the animal.

18. The animal handling assistance system of claim 13, wherein the animal handling assistance apparatus further comprises at least one handle.

19. The animal handling assistance system of claim 13, further comprising a removable cover attachable to the chair.

20. The animal handling assistance system of claim 19, further comprising at least one of a collar strap and a body strap for securing the animal to the chair.
